(19) United States
(12) Patent Application Publication
(10) Pub. No.: US 2017/0027352 A1
(43) Pub. Date: Feb. 2, 2017

(54) CONTAINER FOR TASTING OF AROMAS

(71) Applicant: PACKAGING INNOVATION S. de R. L., Ciudad de Panama (PA)

(72) Inventors: Pedro BALGAÑON CANELA, Ciudad de Panama (PA); Diego BARRERO, Ciudad de Panama (PA)

(73) Assignee: PACKAGING INNOVATION S. de R. L., Ciudad de Panama (PA)

(21) Appl. No.: 14/919,308

(22) Filed: Oct. 21, 2015

(30) Foreign Application Priority Data
Jul. 27, 2015 (ES) 201500521

(51) Int. Cl. A47G 19/30; A47J 47/00; B65D 43/02

(52) U.S. Cl. CPC A47G 19/30; B65D 43/022; A47J 47/00

(57) ABSTRACT

Container for tasting of aromas; that includes: a body with a first cavity to contain the product to be tasted, an upper mouth and inner grooves which facilitate the evaporation of the product and the release of the aromas thereof when shaken; and a tasting cork comprising a lower end coupled to the upper mouth of the body and a second cavity receiving the aroma released by the product; said second cavity containing a lower mouth bounded by a perimeter wall.

### OBJECT OF THE INVENTION

The object of this invention is a container having specific characteristics for tasting aromas.

### FIELD OF APPLICATION OF THE INVENTION

The invention is applicable to the tasting of aromas of diverse products, such as wines, spirits, cigar smoke, perfumes, oils or salsas, among others.

### BACKGROUND

Tasting is the act through which we perform a sensory analysis, using the senses of the palate, of smell as well as that of sight.

Typically, the tasting of wines, spirits and other beverages is done in cups or glasses designed for this purpose which are the instruments of the taster and the medium for sensory analysis.

Thus, for example, in the Utility Model application U 009902939, a device for recognizing aromas is described that is constituted by a base with a housing for a container receptacle of the sample of the product to be tasted and a hood that fits over the base, said hood presenting a closed upper base with a perforated section for the odorous emanations to exit towards the outside and within it a rotary vane which when duly manipulated generates a cyclical movement of air inside the device.

Other tasting containers are described in the patent ES 20130937 which basically consists of a wine tasting cup having a foot with a peripheral lip that serves as a platform for supporting a template provided with a few areas where data is displayed on the various tones of wine, production and aging periods, operating temperature and the most characteristic aromas according to the tones of the wines themselves.

In the Utility Model ES 1113180 U a cup is described that is designed specifically for beer tasting having a body that consists of an upper part which is bell-shaped and outwardly divergent.

Although experts believe olfactory analysis to be the principal part of tasting, devices currently used for this type are simply tasting glasses or cups or other devices, such as to referenced above that do not exhibit characteristics suitable for performing a concentration of the aroma prior to tasting.

### SUMMARY

The container for aroma tasting of this invention has features aimed at enhancing the natural evaporation of the product to be tasted and concentrating odorous particles in a separable cavity of the container and which facilitates the tasting of aromas released by the product in question.

To obtain the proposed objectives, the container for tasting of aromas, which is the object of the invention comprises:—a body that defines a first container cavity of the product to be tasted, the cavity of which is provided with an upper mouth and interior grooves that facilitate evaporation of the product by stirring, agitating and releasing of the aromas thereof; and a tasting cork comprising a lower end coupled to the upper mouth of the body and a second cavity receiving the aroma released by the product; said second cavity contains a lower mouth bounded by a perimeter wall.

The internal grooves in the body act as vortex generators increasing the heat transfer of the mass, allowing better voracity of the gas inside when it enters, leaves or is agitated. The product only needs to be shaken to cause it to rotate over said grooves in the base, causing the aromatic molecules to break, and the finest and deepest aromas to rise up to the second cavity defined in the tasting cork. The cork, once it is separated from the body, is the item used to fully capture the aroma of the aromatic molecules accumulated inside during agitation and evaporation of the product inside the body.

The inner grooves also increase the mass exchange area inside the container, and for this reason when they become wet from the fluid, it facilitates its evaporation. The increase in area and of voracity would be accompanied by its intensification in the mixture of aromas in the container, so this product is also the perfect instrument to capture the aroma created by the pairing of two components, such as a spirit or cigar smoke.

The correct use of the container for tasting of aromas include the following operations:—open the container, withdrawing the tasting cork;—introduce the liquid or gas into the inside of the container; introducing first the liquid if the tasting to be performed involves a mixture of a liquid product and a gaseous one;—close the body of the container using the tasting cork;—shake the container up and down, holding down the tasting cork;—wait about three seconds so that the aroma may be deposited onto the tasting cork and lastly—withdraw the tasking cork and smell the aromatic particles deposited thereon.

### BRIEF DESCRIPTION OF THE FIGURES

To complement the description being made and in order to facilitate understanding of the characteristics of the invention, the present specification is accompanied by a set of drawings in which, with illustrative and non-limitative character, the following has been represented:

FIG. 1 shows a view in perspective of the container for tasting of aromas according to the invention.

FIG. 2 shows a view in perspective of the container of the previous Figure with the plug separated from the body.

FIGS. 3 and 4 show respective views of the container of the preceding Figures, sectioned along a vertical plane, in the closed and open positions respectively.

FIG. 5 shows a view of the bottom of the container body allowing observation of internal grooves

### DETAILED DESCRIPTION

The container for tasting of aromas which is the object of the invention, comprises:—a body (1) that defines a first cavity (11) designed to contain the product to be tasted and that is provided with an upper mouth (12) for the coupling of the lower end (22) of a cork (2) provided with a second cavity (21), with a lower mouth (23), for the accumulation of the aroma released by the product contained in the body (1).

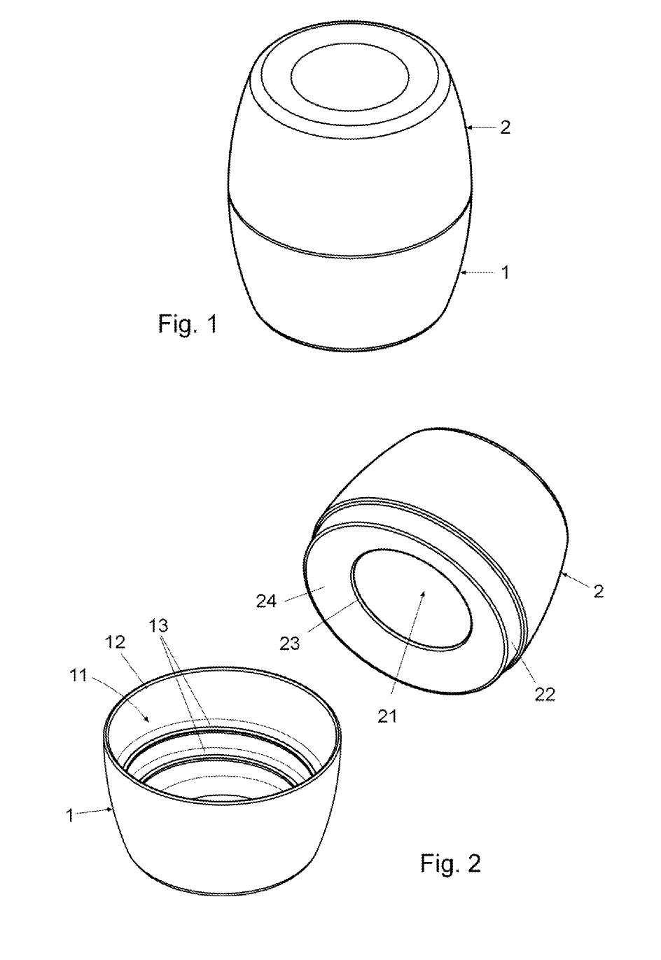

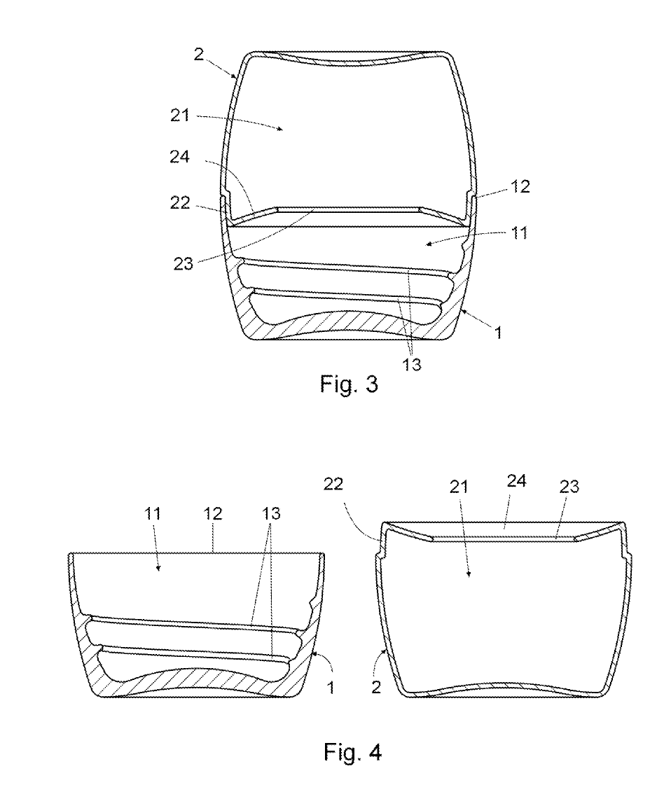

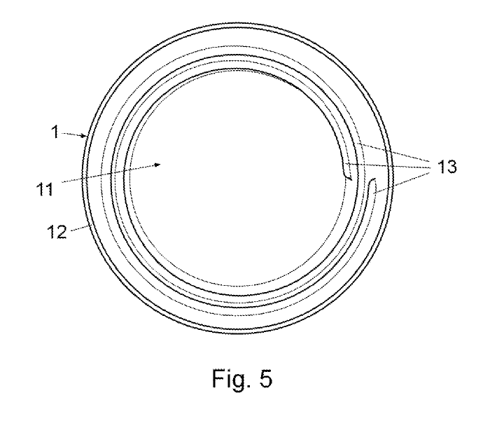

As can be seen in FIGS. 2 to 5, the first cavity (11) of the body (1) has inner grooves (13) which facilitates the evaporation of the product through shaking and the release of the aromas thereof.

In this example of an embodiment, the inner grooves (13) are constituted by a helical projection defined on the inner surface of the body (1).

The lower mouth (23) of the cork is delimited by a peripheral wall (24) which in this embodiment is converged towards the inside of said second cavity, and facilitates the entrance of the aromatic particles, contributing to their retention inside the cork (2) until the moment in which the aromas are tasted.

Once the nature of the invention has been sufficiently described, as well as an example of a preferred embodiment, let it be known for all purposes that the materials, shape, size and arrangement of the elements described can be modified, provided that this does not suppose an alteration of the essential characteristics of the invention claimed below.

1. Container for tasting of aromas, comprising: a body with a first cavity to contain the product to be tasted, provided with an upper mouth, wherein the body comprises inner grooves that facilitate the evaporation of the product and the release of the aromas thereof upon being shaken; the container further comprising a tasting cork that includes a lower end coupled in the upper mouth of the base and a second cavity to receive the aromas released by the product; said second cavity containing a lower mouth bounded by a perimeter wall.

2. The container according to claim 1, wherein the inner grooves are constituted by a helical projection defined on the inner surface of the body.
